(19) United States
(12) Patent Application Publication
(10) Pub. No.: US 2005/0025565 A1
(43) Pub. Date: Feb. 3, 2005

(54) Securing device for a spring

(75) Inventors: Reuven Unger, Athens, OH (US); Seon Young Kim, Kyunggi-do (KR); Jae Sang Park, Pusan-si (KR); Sung Tae Kim, Seoul (KR)

Correspondence Address: GREENBLUM & BERNSTEIN, P.L.C., 1950 ROLAND CLARKE PLACE, RESTON, VA, 20191, US

(73) Assignees: LG Electronics Inc., Seoul (KR); Sunpower, Inc., Athens, OH (US)

(21) Appl. No.: 10/627,623

(22) Filed: Jul. 28, 2003

(51) Int. Cl. F16B 2/00

(52) U.S. Cl. 403/373

(57) ABSTRACT

A securing device for a spring is provided, the device having a generally hollow spring support having a spring mount having a projection on an inner side of the spring support and configured to support the spring, the device further having a generally annular coupling ring configured to connect to the spring support to secure the spring to the spring support.

### CROSS-REFERENCE TO RELATED APPLICATION

The present application is related to Korean Patent Application Nos. 2002-006335 and 2002-006340, both filed on Feb. 4, 2002, the disclosures of which are expressly incorporated by reference in their entirety.

### BACKGROUND OF THE INVENTION

1. Field of the Invention

The present invention relates to a securing device for a spring, and more particularly, to a securing device for a spring which allows an operator to perform fixing and assembly operations of the spring in an isolation glove box, and provides a more convenient way for fixing the spring on a spring support.

2. Description of the Related Art

Generally, a variety of reciprocating devices, including but not limited to free-piston machines, are often used in a heat regeneration type of refrigerator, including but not limited to Stirling coolers, Gifford-McMahon refrigerators, and the like. A conventional free-piston machine is described in U.S. Pat. No. 6,293,184, which issued to Unger on Sep. 25, 2001, the contents of which are expressly incorporated by reference in its entirety.

As shown in FIG. 1, a reciprocating device 1 includes a driving part 100 for compressing a working gas through linear reciprocating movement of a piston 140 by electromagnetic mutual interaction of a linear motor 130, a conducting part 200 for absorbing a part of the heat of the gas, which is compressed in high temperature and pressure in the driving part 100, or conducting the heat to the outside, and a cooling part 300 for transforming the gas into a low temperature state by a thermodynamic cycle while the gas reciprocally moves in a regenerator 330 after an amount of heat is absorbed by the conducting part 200.

The driving part 100 includes a tube 120 having a space therein, and is fastened to a frame 110 concentrically arranged with inner/outer conducting parts 210 and 220 respectively, and having a displacer 310. A linear motor 130 has a stator 130a and an armature (magnet sleeve) 130b, and installed in the inside the shell tube 120. A piston 140 is fixed to one end of the armature 130b of the linear motor 130, and undergoes the same movement as the armature 130b that moves in a linear direction due to the electromagnetic mutual interaction of the linear motor 130. A cylinder 150 is attached at the center of the inside the frame 110 so that the linear reciprocating movement of the piston 140, which is inserted therein with to the inner conducting part 210, can be evenly or uniformly transmitted to the displacer 310. A planar spring 160 is provided for supporting one end of a displacer rod 320 so that the displacer rod 320 inserted inside the piston 140 and the displacer 310 are threadedly coupled with the rod 320 are concentric/coaxial with the piston 140 and with the inner conducting part 210. A spring support 170 fixedly supports the planar spring 160. Reference numeral 130c is an inner stator, one of the elements of the linear motor 130.

The conducting part 200 includes the inner conducting part 210 oriented toward the frame 110 and concentric to the cylinder 150 and the piston 140, such that the displacer 310 makes a linear reciprocating movement corresponding to the linear reciprocating movement of the piston 140. The conducting part 200 further includes an outer conducting part 220 fixed to the external circumferential surface of the inner conducting part 210.

The cooling part 300 includes a displacer 310 and a displacer rod 320 moving reciprocally in a linear direction within the range of elastic deformation of the planar spring 160, which is fixed in the inside the inner conducting part 210 and supports one end of the displacer rod 320. A regenerator 330 is installed in the displacer 310 and stores the heat of the gas in a high temperature and pressure state after being moved by the piston 140 and being compressed into the displacer 310, and after the gas is expanded, transmitting the stored heat to the expanded gas in a low temperature state, thereby compensating for the temperature of the gas changing back to a low temperature. A displacer housing 340 accommodates the displacer 310 therein, and has a cooling side part 350 fixed to one end of the cylinder. The cooling side part 350 exchanges heat with the outside (i.e. exterior) so that the gas passing through the regenerator 330 installed inside the displacer 310 is expanded and returned to a low temperature.

Since the reciprocating device 1 cannot use oil for lubrication, it requires precise centering during assembly, and further requires a device for preventing eccentricity during operation. In other words, since the reciprocating device breaks down if weak friction surfaces are abraded, significant attention and precise assembly is required.

For this purpose, gas bearings are used in sliding portions. However, since a supporting force of the gas bearing is weak, centering and eccentricity prevention are always required.

The planar spring, also known as a “flexure” spring, is frequently used as an eccentricity-preventing device. By screwing the planar spring 160 to the spring support 170 through a plurality of fixing holes formed at an edge of the planar spring 160 with the displacer rod 320 inserted into the middle of the planar spring 160, the planar spring 160 is fixed to the spring support 170. In this way, a screw fixation method is mainly used for the support of the planar spring.

However, in reality, an operator has to wear thick rubber gloves in order to perform an assembly process in the isolation glove box filled with nitrogen. Under such a condition, it is very difficult to assemble small screws, as the operators tactile sensation is reduced by the thick rubber gloves.

Therefore, it is a problem that a fixing operation of the planar spring 160 to the planar spring support by using small screws is troublesome and inconvenient, resulting in serious deterioration of work efficiency.

### SUMMARY OF THE INVENTION

Accordingly, the present invention has been made keeping in mind the above problems occurring in the prior art, and a feature of the present invention provides a securing device for a planar spring for fixing a displacer, which is capable of allowing an operator wearing rubber gloves to perform fixing and assembly operations of the planar spring in a glove box and fixing the planar spring at a spring support simply by fixing the planar spring into the spring support by a threaded combination of the spring support in which a spring mount is provided and a covering member (instead of the conventional screw fixation method by which the planar spring is fixed to the spring support by use of screws).

Another feature of the present invention provides a fixing device for a spring, the device being capable of allowing an operator wearing rubber gloves to perform simple fixing and assembly operations of the planar spring in a glove box and fixing the planar spring at a spring support in which a spring mount is provided at maximal combination force of the spring support and a covering member in which fixation holes into which fixing tools are inserted are formed, by using the fixing tools.

Yet another feature of the present invention provides a securing device for a spring for fixing a displacer, which is capable of improving work efficiency through reduction of the number of assembly steps for the planar spring and the spring support and hence reducing work time.

The present invention provides a fixing device for a spring, having a generally hollow spring support including a spring mount having a projection on an inner side of the spring support and configured to support the planar spring. The fixing device further has a generally hollow covering member configured to connect to the spring support to affix the planar spring to the spring support. The spring support may have a first inner diameter and a second inner diameter, and the spring mount may radially inwardly project at a region between the first and second inner diameters.

According to a feature of the invention, first threads may be formed on an inner periphery of the spring mount of the spring support, and second threads may be formed on an outer periphery of the covering member, the first and second threads configured to threadedly engage each other.

Additionally, the covering member may be a synthetic resin member and may be configured to at least one of press and fix a periphery of the spring via a generally ring-shaped nut.

A securing device for a spring according to another aspect of the invention has a generally hollow spring support including a spring mount having a projection on an inner side of the spring support and configured to support the spring. The fixing device further has a generally hollow covering member configured to connect to the spring support to affix the spring to the spring support, and a plurality of fixation holes penetratingly formed through the covering member, the plurality of fixation holes configured to accept a respective plurality of fixation tools.

Additionally the plurality of fixation holes may be at an interval of one of approximately 90° and 180° on the covering member.

A fixing device according to still another aspect of the invention includes a generally hollow spring support including a spring mount having a projection on an inner side of the spring support and configured to support the spring. Also provided is a generally hollow covering member configured to connect to the spring support to affix the spring to the spring support, and a plurality of threaded holes in the covering member.

A securing device for a spring according to a further aspect of the invention has a generally hollow spring support including a spring mount having a projection on an inner side of the spring support and configured to support the spring, a generally hollow covering member configured to connect to the spring support to affix the spring to the spring support, and a plurality of grooves in the covering member.

Additionally, the plurality of grooves may be at an interval of one of approximately 90° and 180° on the covering member.

A securing device for a spring according to yet a further aspect of the invention has a generally hollow spring support including a spring mount having a projection on an inner side of the spring support and configured to support the spring, a generally hollow covering member configured to connect to the spring support for fixing the spring to the spring support, and a plurality of projections in the covering member.

Also, the plurality of projections may be at an interval of one of approximately 90° and 180° on the covering member.

A method of the present invention for fixing a spring to a reciprocating device, includes inserting a spring into a generally hollow spring support such that a projection of the spring support supports the spring, and connecting a generally hollow connecting member to the spring support such that the spring is secured and sandwiched between the connecting member and the projection.

Other exemplary embodiments and advantages of the present invention may be ascertained by reviewing the present disclosure and the accompanying drawings.

### BRIEF DESCRIPTION OF THE DRAWINGS

The present invention is further described in the detailed description which follows, in reference to the noted plurality of drawings by way of non-limiting examples of certain embodiments of the present invention, in which like numerals represent like elements throughout the several views of the drawings, and wherein:

FIG. 1 is a schematic view showing a construction of a conventional reciprocating device;

FIG. 2A is a plan view of a conventional spring for use in the conventional reciprocating device;

FIG. 2B is a sectional view showing how a spring is fixed at a spring support by a fixing device in FIG. 1;

FIG. 3 is an exploded sectional view of a securing device for a spring according to a first embodiment of the present invention;

FIG. 4 is a combined sectional view of a securing device for a spring according to the first embodiment of the present invention;

FIG. 5A is a plan view of a covering member according to a second embodiment of the present invention;

FIG. 5B is an exploded sectional view of a securing device for a spring according to the second embodiment of the present invention;

FIG. 6 is a sectional view of a securing device for a spring according to the second embodiment of the present invention;

FIG. 7A is a plan view of a covering member according to a third embodiment of the present invention;

FIG. 7B is a sectional view of a securing device for a spring according to the third embodiment of the present invention, taken along the line A-A of FIG. 7A;

FIG. 8A is a plan view of a covering member according to a fourth embodiment of the present invention;

FIG. 8B is a sectional view of a securing device for a spring according to the fourth embodiment of the present invention, taken along the line B-B of FIG. 8A;

FIG. 9A is a plan view of a covering member according to a fifth embodiment of the present invention;

FIG. 9B is a sectional view of a securing device for a spring according to the fifth embodiment of the present invention, taken along the line C-C of FIG. 9A; and

FIG. 10 is an exploded sectional view of a securing device for a spring according to a sixth embodiment of the present invention

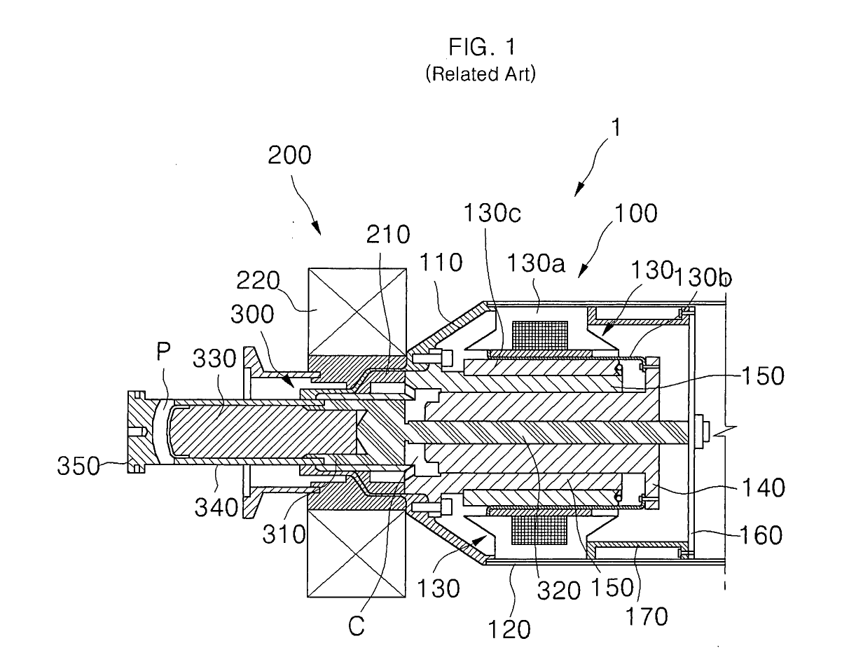

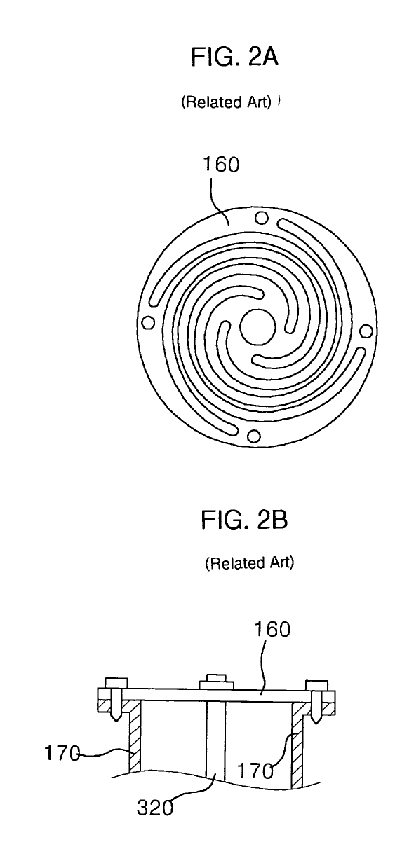

### DETAILED DESCRIPTION OF THE INVENTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice.

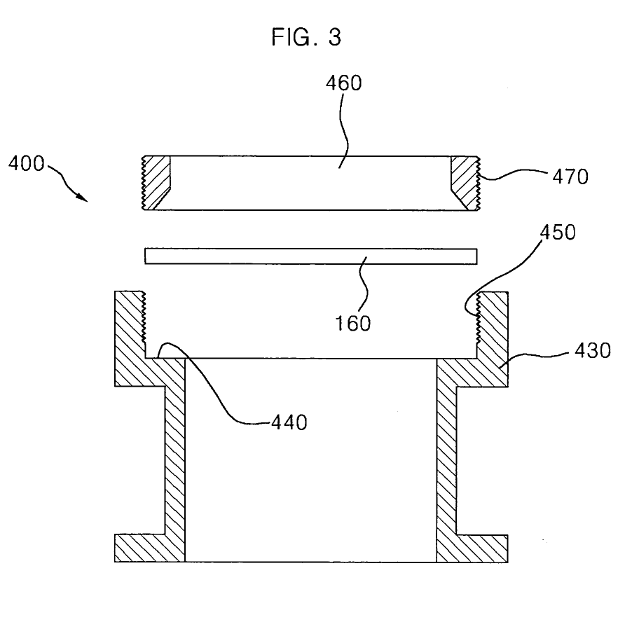

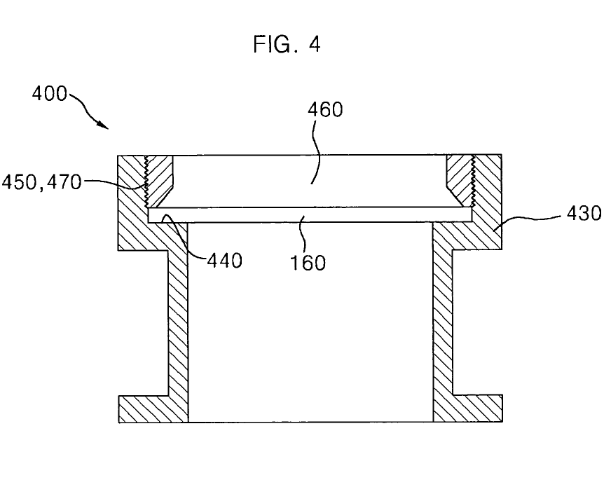

FIG. 3 is an exploded sectional view of a securing device for a spring according to a first embodiment of the present invention, and FIG. 4 is a combined (i.e., assembled) sectional view of a securing device for a spring according to the first embodiment of the present invention. For example, while some of the figures may illustrate a free-piston Stirling engine, it is readily appreciable by those skilled in the art that the present invention is applicable to a wide variety of reciprocating and/or oscillating devices. Additionally, while some of the figures illustrate a planar spring, it is readily appreciable by those skilled in the art that the present invention is applicable to fix a wide variety of springs.

As shown in FIGS. 3 and 4, a fixing device 400 of a spring for fixing a displacer according to a first embodiment of the present invention is for fixing the spring 160 to the spring support 430 by combining forces between the spring support 430 and the hollow covering member (coupling ring) 460, connecting the hollow covering member 460 with the spring support 430 with the spring 160 mounted on a spring mount 440 having a round projecting shape (as opposed instead of the conventional troublesome and inconvenient fixing method for fixing the spring 160 at the spring support 170 using small screws or bolts). Accordingly, the combination of the spring support 430 and the covering member 460 is achieved by fastening of a female screw 450 formed on an inner periphery of the spring mount 440 of the spring support 430 with a male screw 470 formed on an outer periphery of the covering member 460.

In the present invention, the spring support 430 as one of the elements of the fixing device 400 of the spring, has a hollow shape and has one portion at which the spring mount 440, having a round projecting shape in which the spring 160 is mounted, is formed and extends for a predetermined depth from an upper end of the member 430, and has another portion that is slightly wider than a diameter of the spring mount 440 such that the spring mount 440 is formed thereby. Also, the female screw 450 for fastening the covering member 460 with the spring mount 440 is formed on the inner periphery of the spring mount 440.

In addition, the covering member 460 is also formed to have a hollow shape such that a displacer rod (not shown) is fixed at the middle of the spring 160 mounted on the spring mount 440 of the spring support 430. Also, the male screw 470 is formed on the outer periphery of the covering member 460 for threadedly engaging the female screw 450 formed on the spring mount 440 of the spring support 430.

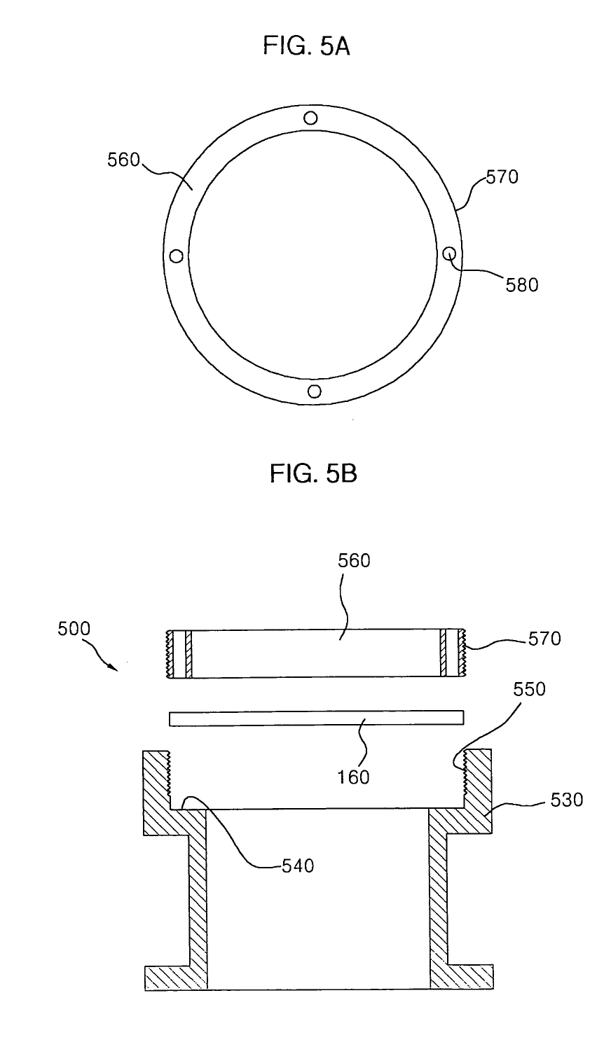

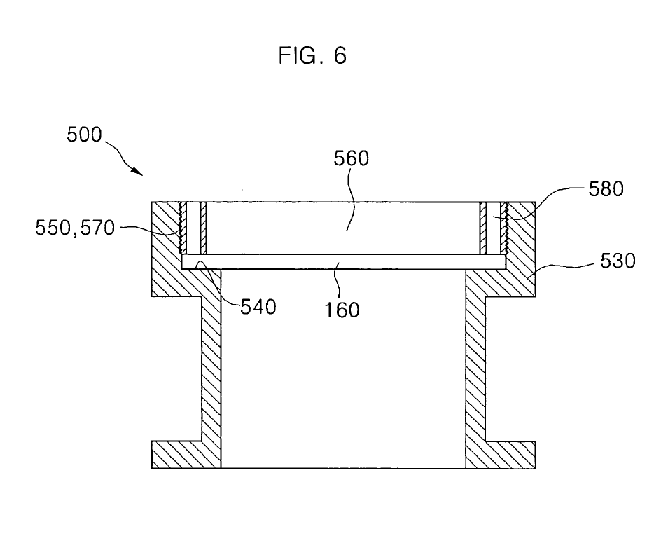

FIG. 5A is a plan view of a covering member according to a second embodiment of the present invention, FIG. 5B is an exploded sectional view of a securing device for a spring according to the second embodiment of the present invention, and FIG. 6 is a combined (i.e., assembly) sectional view of a securing device for a spring according to the second embodiment of the present invention.

As shown in FIGS. 5A, 5B and 6, a fixing device 500 of a spring for fixing a displacer according to the second embodiment of the present invention is for fixing the spring 160 to spring support 530 by a combining force between the spring support 530 and hollow covering member (coupling ring) 560 by coupling the hollow covering member 560, having a plurality of fixation holes 580 into which fixation tools (not shown) are inserted, to the spring support 530, having the spring 160 mounted on its spring mount 540, having a round projection shape (instead of the conventional troublesome and inconvenient prior art fixing method for fixing the spring 160 at the spring support 170 using small screws or bolts). Accordingly, fastening of the spring support 530 and the covering member 560 is achieved by a spiral (i.e., threaded) joining of a female screw 550 formed on an inner periphery of the spring mount 540 of the spring support 530 and a male screw 570 formed on an outer periphery of the covering member 560.

In the present invention, spring support 530 as one element of the fixing device 500 of the spring has a hollow shape and has one portion at which the spring mount 540 having a round projection shape on which the spring 160 is mounted and extends for a predetermined depth from an upper end of the spring support 530, and has another portion that is slightly larger than a diameter of the spring mount 540 such that the spring mount 540 is formed. Also, the female screw 550 for fastening the covering member 560 with the spring mount 540 is formed on the inner periphery of the spring mount 540.

In addition, the covering member 560 is also formed to have a hollow shape such that a displacer rod (not shown) is fixed at the middle of the spring 160 mounted on the spring mount 540 of the spring support 530. Also, the male screw 570 is formed on the outer periphery of the covering member 560 for threadedly engaging the female screw 550 formed on the spring mount 540 of the spring support 530.

In addition, in order to increase the connecting forces between the spring support 530 and the covering member 560, the plurality of fixation holes 580 each having a predetermined diameter, into which the fixation tools are inserted, are penetratingly formed through the covering member 560. Specifically, each fixation tool used in each embodiment has protrusions/voids configured to engage complimentary voids/protrusions of the covering member 560. As illustrated, the fixation holes 580 are formed at an interval of approximately 90° or 180° about the covering member 560, although other intervals are within the scope of the present invention. For example, for a covering member 560 having fixation holes 580 formed at 90° about the covering member, a corresponding fixation tool would have protrusions formed at 90° on the covering member. Thus, with such a configuration, a fixation tool can securely engage the covering member 560, and an operator performing fixing or assembly operations can apply a sufficient amount of torque to the covering member to secure it to the spring support 530.

Hereinafter, only the difference between the constructions of fixing devices of springs for fixing (or securing) displacers according to the third, fourth, and fifth embodiments of the present invention and the securing device for the spring according to the second embodiment of the present invention will be described.

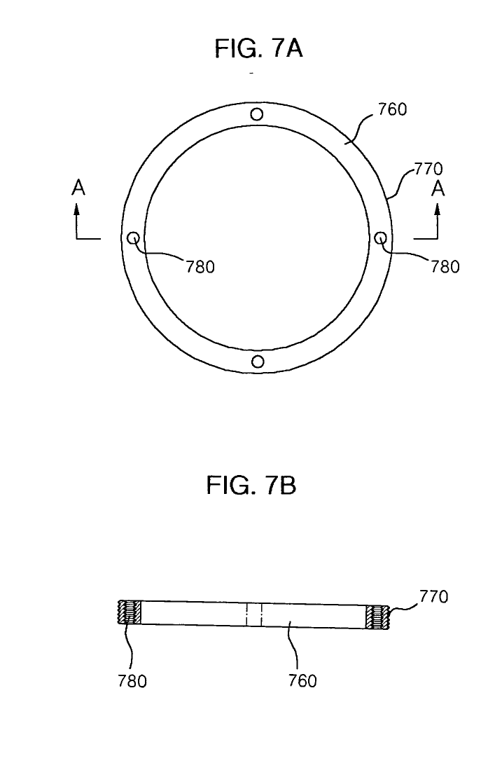

FIG. 7A is a plan view of a covering member according to a third embodiment of the present invention and FIG. 7B is a sectional view of a securing device for a spring according to the third embodiment of the present invention, taken along the line A-A of FIG. 7A.

As shown in FIGS. 7A and 7B, the securing device for the spring according to the third embodiment of the present invention has a plurality of female screw holes 780 (instead of the plurality of the fixation holes 580 having a predetermined diameter, into which the fixation tools are inserted). The plurality of female screw holes 780 are penetratingly formed through covering member 760 in order to increase the connecting force between the spring support 430, 530 and the covering member. Specifically, a fixation tool (not shown) having a complimentary and corresponding set of male screws is configured to penetratingly engage the female screw holes 780 of the covering member 760 so that an operator performing fixing or assembly operations can apply a sufficient amount of torque to the covering member to secure it to the spring support 430,530.

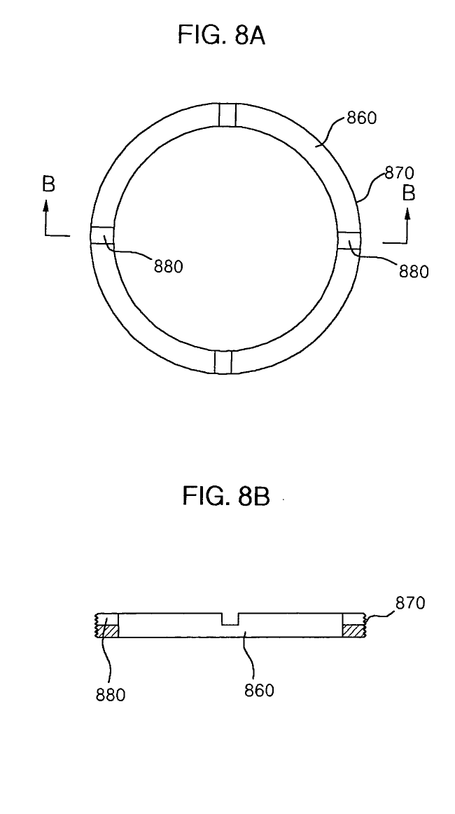

FIG. 8A is a plan view of a covering member according to a fourth embodiment of the present invention, and FIG. 8B is a sectional view of a securing device for a spring according to the fourth embodiment of the present invention, taken along the line B-B of FIG. 8A.

As shown in FIGS. 8A and 8B, the securing device for the spring according to the fourth embodiment of the present invention has a plurality of grooves 880 (instead of a plurality of the fixation holes 580 having the specific diameter, into which the fixation tools are inserted). The plurality of combination grooves 880 are formed on covering member 860 in order to increase the connecting force between the spring support 430, 530 and the covering member 860. Specifically, a fixation tool (not shown) having a complimentary and corresponding set of protrusions is configured to penetratingly engage the grooves 880 of the covering member 860 so that an operator performing fixing or assembly operations can apply a sufficient amount of torque to the covering member to secure it to the spring support 430,530.

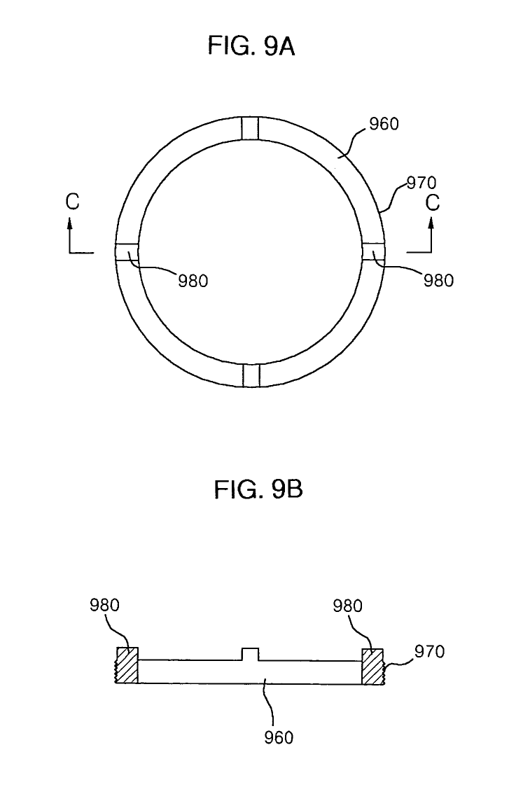

FIG. 9A is a plan view of a covering member according to a fifth embodiment of the present invention, and FIG. 9B is a sectional view of a securing device for a spring according to the fifth embodiment of the present invention, taken along the line C-C of FIG. 9A

As shown in FIGS. 9A and 9B, the securing device for the spring according to the fifth embodiment of the present invention has a plurality of combination projectors 980 (instead of a plurality of the fixation holes 580 having the specific diameter, into which the fixation tools are inserted). The plurality of combination projections 980 are formed on covering member 960 in order to increase the connecting force between the spring support 430, 530 and the covering member 960. Specifically, a fixation tool (not shown) having a complimentary and corresponding set of channels is configured to penetratingly engage the projections 980 of the covering member 960 so that an operator performing fixing or assembly operations can apply a sufficient amount of torque to the covering member to secure it to the spring support 430,530.

Hereinafter, as still another embodiment (a sixth embodiment) of the present invention, a securing device for a spring in which the screw configuration in the aforementioned embodiments is eliminated and the entire periphery of the spring is pressed and fixed by a nut of a ring shape will be described.

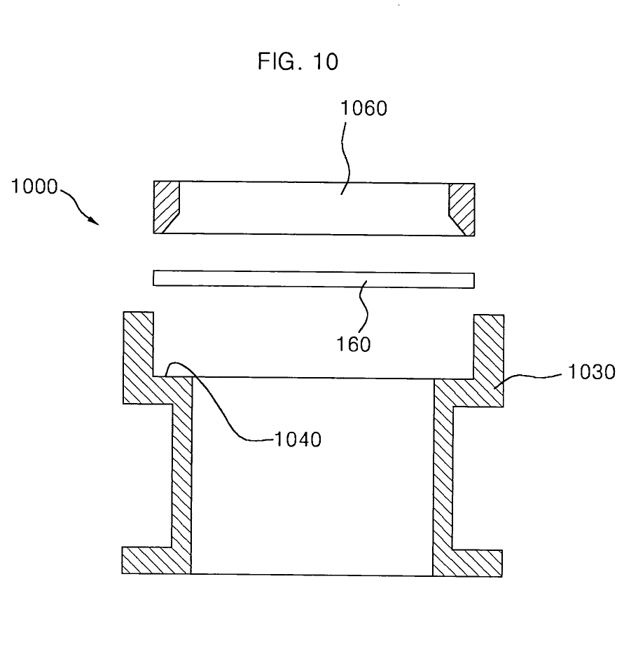

FIG. 10 is an exploded sectional view of a securing device for a spring according to the sixth embodiment of the present invention.

As shown in FIG. 10, the securing device for the spring according to the sixth embodiment of the present invention includes a spring support 1030 having a spring mount 1040 with screws (450 and 550 in FIGS. 4, 5A and 5B) eliminated such that the spring 160 is pressingly fixed in a manner other than the threaded combining systems of the spring support (430 and 530 in FIGS. 4, 5A and 5B) and the covering member (coupling ring) (460, 560, 760, 860 and 960 in FIGS. 4 to 9B), in that a hollow covering member 1060 made from synthetic resin having elasticity such that specific weight or pressure is applied to the spring support 1030.

This configuration provides a combination construction of a ring nut, by which an operator wearing a thick glove can perform an assembling operation. In other words, the screw configuration is eliminated and the entire periphery of the spring is pressed and fixed by the ring-shaped nut.

In contrast to the fixing devices of the springs according to the second, third, fourth and fifth embodiments of the present invention, the female screws formed on the inner periphery of the spring mount of the spring support and the male screws formed on the outer periphery of the covering member can be eliminated. In other words, the screw configuration is eliminated and the entire periphery of the spring is pressed and fixed by the ring-shaped nut.

It is of course understood that various features of the different embodiments can be combined within the scope of the present invention.

Now, an operation of the securing device for the spring for fixing the displacer according to the present invention will be described in terms of a combination process of the spring support (in which the spring is mounted on the spring mount of the spring support) and the covering member.

As shown in FIGS. 3 and 4, in order to fix the spring 160 elastically deformed by the linear reciprocal motion of the displacer, which contains the reproducer, and the displacer rod at the spring support 430, the spring into which the displacer rod is inserted is first mounted on the spring mount 440 of the spring support 430. Subsequently, by the male screw 470 of the hollow covering member 460 is threadedly engaged with the female screw 450 of the spring mount of the spring support 430 after the position of the displacer rod is adjusted, the spring 160 is fixed onto the spring support 430.

In addition, as shown in FIGS. 5A, 5B, 6A and 6B, in order to increase the combining (i.e., holding) force between the spring support 530 and the covering member 560, fixation tools (not shown) may be inserted into the plurality of fixation holes 580 penetratingly formed through the covering member 560. Subsequently, by rotating the fixation tools in a threading direction, the spring support 530 and the covering member 560 are combined to each other with maximal combination force. At that time, as the bottom of the covering member 560 presses the entire periphery of the spring 160 mounted on the spring mount 540, the spring 160 is fixed to the spring support 530.

As described above, an advantage of the present invention is that an operator wearing a rubber glove can perform fixation and assembly operations of the spring in a glove box and fix the spring at the spring support more easily, by fixing the spring to the spring support by fastening the spring support in which the spring mount is provided and the covering member (instead of the conventional screw fixation method in which the spring is fixed to the spring support using screws).

In addition, by rotating the fixation tools inserted into the fixation holes in a threading direction so that the spring support and the covering member are combined to each other with maximal combining force, the spring can be simply fixed to the spring support.

Therefore, the present invention improves work efficiency through a reduction in the number of assembly steps for the spring and the spring support, thereby reducing the working time.

It is noted that the foregoing examples have been provided merely for the purpose of explanation and are in no way to be construed as limiting of the present invention. While the present invention has been described with reference to certain embodiments, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

1. A securing device for a spring, comprising:
a generally annular spring support comprising a spring mount that projects on an inner side of the spring support and is configured to support the spring; and
a generally annular coupling ring configured to connect to the spring support, to secure the spring between the spring support and the coupling ring.

2. The securing device according to claim 1, wherein:
said spring support has a first inner diameter and a second inner diameter; and
said spring mount radially inwardly projects at a region between said first inner diameter and said second inner diameter.

3. The securing device according to claim 1, wherein first threads are formed on an inner periphery of the spring mount of the spring support, and second threads are formed on an outer periphery of the coupling ring, the first and second threads configured to threadedly engage each other.

4. The securing device according to claim 1, wherein the coupling ring comprises synthetic resin and is configured to at least one of press and fix a periphery of the spring via a generally ring-shaped nut.

5. A securing device for a spring, comprising:
a generally annular spring support comprising a spring mount that projects on an inner side of the spring support and is configured to support the spring;
a generally annular coupling ring configured to connect to the spring support, to secure the spring between the spring support and the coupling ring; and
a plurality of fixation holes penetratingly formed through the coupling ring, the plurality of fixation holes configured to accept a respective plurality of fixation tools.

6. The securing device according to claim 5, wherein:
said spring support has a first inner diameter and a second inner diameter; and
said spring mount radially inwardly projects at a region between said first inner diameter and said second inner diameter.

7. The securing device according to claim 5, wherein first threads are formed on an inner periphery of the spring mount of the spring support, and second threads are formed on an outer periphery of the coupling ring, the first and second threads configured to threadedly engage each other.

8. The securing device according to claim 5, wherein the coupling ring comprises synthetic resin and is configured to at least one of press and fix a periphery of the spring via a generally ring-shaped nut.

9. The securing device according to claim 5, wherein the plurality of fixation holes are at an interval of one of approximately 90° and 180° on the coupling ring.

10. A securing device for a spring, comprising:
a generally annular spring support comprising a spring mount that projects on an inner side of the spring support and is configured to support the spring;
a generally annular coupling ring configured to connect to the spring support, to secure the spring between the spring support and the coupling ring; and
a plurality of threaded holes in the coupling ring.

11. The securing device according to claim 10, wherein:
said spring support has a first inner diameter and a second inner diameter; and
said spring mount radially inwardly projects at a region between said first inner diameter and said second inner diameter.

12. The securing device according to claim 10, wherein first threads are formed on an inner periphery of the spring mount of the spring support, and second threads are formed on an outer periphery of the coupling ring, the first and second threads configured to threadedly engage each other.

13. The securing device according to claim 10, wherein the coupling ring comprises synthetic resin and is configured to at least one of press and fix a periphery of the spring with a generally ring-shaped nut.

14. The securing device according to claim 10, wherein the plurality of threaded holes are at an interval of one of approximately 90° and 180° on the coupling ring.

15. A securing device for a spring, comprising:
a generally annular spring support comprising a spring mount that projects on an inner side of the spring support and is configured to support the spring;
a generally annular coupling ring configured to connect to the spring support, to secure the spring between the spring support and the coupling ring; and
a plurality of grooves in the coupling ring.

16. The securing device according to claim 15, wherein:
said spring support has a first inner diameter and a second inner diameter; and
said spring mount radially inwardly projects at a region between said first inner diameter and said second inner diameter.

17. The securing device according to claim 15, wherein first threads are formed on an inner periphery of the spring mount of the spring support, and second threads are formed on an outer periphery of the coupling ring, the first and second threads configured to threadedly engage each other.

18. The securing device according to claim 15, wherein the coupling spring comprises synthetic resin and is configured to at least one of press and fix a periphery of the spring via a generally ring-shaped nut.

19. The securing device according to claim 15, wherein the plurality of grooves are at an interval of one of approximately 90° and 180° on the coupling ring.

20. A securing device for a spring, comprising:
a generally annular spring support comprising a spring mount that projects on an inner side of the spring support and is configured to support the spring;
a generally annular coupling ring configured to connect to the spring support, to secure the spring between the spring support and the coupling ring; and
a plurality of projections in the coupling ring.

21. The securing device according to claim 20, wherein:
said spring support has a first inner diameter and a second inner diameter; and
said spring mount radially inwardly projects at a region between said first inner diameter and said second inner diameter.

22. The securing device according to claim 21, wherein a first threads are formed on an inner periphery of the spring mount of the spring support, and second threads are formed on an outer periphery of the coupling ring, the first and second threads configured to threadedly engage each other.

23. The securing device according to claim 21, wherein the coupling ring comprises synthetic resin and is configured to at least one of press and fix a periphery of the spring with a generally ring-shaped nut.

24. The securing device according to claim 21, wherein the plurality of projections are at an interval of one of approximately 90° and 180° on the coupling ring.

25. A method of securing a spring to a reciprocating device, the method comprising:
inserting a spring into a generally annular spring support such that a spring mount of the spring support supports the spring; and
connecting a generally annular coupling ring to the spring support such that the spring is secured and sandwiched between the coupling ring and the projection.
